(19) United States
(12) Patent Application Publication
(10) Pub. No.: US 2005/0104874 A1
(43) Pub. Date: May 19, 2005

(54) Display apparatus and method of eliminating afterimage thereof

(76) Inventor: Hyung-il Koh, Suwon-si (KR)

Correspondence Address: STANZIONE & KIM, LLP, 1740 N STREET, N.W., FIRST FLOOR, WASHINGTON, DC, 20036, US

(21) Appl. No.: 10/948,198

(22) Filed: Sep. 24, 2004

(30) Foreign Application Priority Data
Nov. 17, 2003 (KR) 2003-81059

(51) Int. Cl. G09G 5/00

(52) U.S. Cl. 345/204

(57) ABSTRACT

A display apparatus having a display panel displaying an image thereon, including a GUI generator providing a graphic user interface to set an afterimage elimination area, in which an afterimage is to be eliminated, on the display panel; a user input unit allowing a user to set the afterimage elimination area through the graphic user interface; and a controller controlling the GUI generator to display an afterimage elimination image in the afterimage elimination area set by operating the user input unit on the display panel. With this configuration, the general inventive concept provides a display apparatus and a method of eliminating an afterimage, in which an afterimage elimination can be applied to only a specific area of the display panel.

### CROSS-REFERENCE TO RELATED APPLICATIONS

This application claims the benefit of Korean Patent Application No. 2003-81059, filed Nov. 17, 2003, in the Korean Intellectual Property Office, the disclosure of which is incorporated herein by reference.

### BACKGROUND OF THE INVENTION

1. Field of the Invention

The present general inventive concept relates to a display apparatus and a method of eliminating an afterimage thereof, and more particularly, to a display apparatus and a method of eliminating an afterimage, in which an afterimage elimination can be applied to only a specific area of a display panel.

2. Description of the Related Art

A cathode ray tube (CRT) has been generally used for a display apparatus, but the CRT is relatively heavy and bulky and consumes relatively much electric power. Therefore, recently, a flat panel display (FPD) is widely used for the display apparatus. Such an FPD employs a liquid crystal display panel (LCD), a plasma display panel (PDP), etc.

The PDP and the LCD are being widely used in a computer monitor, a television (TV), etc. In the case of the computer monitor, one picture is likely to be displayed constantly, that is, a still picture is frequently displayed for a long time. Further, in the case of the TV, it is common enough to display the still picture, such as a color bar picture, for a long time.

However, after the PDP or the LCD continues displaying the still picture for a long time, an afterimage, due to the still picture, lingers on the PDP or the LCD. For example, in the case of the PDP, a phosphor provided in a barrier rib of a PDP cell is damaged after the still picture is continuously displayed, so that the afterimage lingers between a brightness part and a darkness part. Further, in the case of the LCD, the LCD does not promptly respond to a video signal change after the still picture being continuously displayed is replaced with a new picture, so that the afterimage lingers due to the still picture. Such an afterimage deteriorates picture quality, thereby causing consumer complaints, as well as other problems.

To reduce the afterimage in the display apparatus using the LCD or the PDP, various methods have been proposed. For example, when a predetermined time has passed since the still picture has been first displayed, the still picture is controlled to get darker and darker, thereby reducing the afterimage. Further, when a predetermined time has passed since the still picture has been first displayed, the still picture is controlled to inch vertically or horizontally to be changed by a pixel, thereby reducing the afterimage.

However, the above proposed methods of eliminating the afterimage are applied to the whole picture (i.e., the whole display panel), which is achieved by controlling the whole display picture to get darker or to inch vertically or horizontally. Therefore, even though the still picture is continuously displayed on only a specific area of the display panel, the foregoing afterimage eliminations are applied to the whole picture being displayed on the display panel in order to eliminate the afterimage lingering on the specific area since it is impossible to apply the above afterimage elimination techniques to only the specific area. For example, in the case where the display apparatus displays a moving picture of a TV broadcasting system, if a name of the TV broadcasting system, such as “MBC HD”, “KBS1”, etc., is continuously displayed on a specific area of the display panel while the moving picture is displayed, the specific area displays the name of the TV broadcasting system as a still picture, so that the afterimage, due to the name of the TV broadcasting system, lingers on the specific area of the PDP or the LCD after the TV broadcasting system has been changed by changing a TV channel.

### SUMMARY OF THE INVENTION

Accordingly, it is an aspect of the present general inventive concept to provide to a display apparatus and a method of eliminating an afterimage, in which the afterimage elimination can be applied to a specific area of a display panel.

Additional aspects and/or advantages of the present general inventive concept will be set forth in part in the description which follows and, in part, will be obvious from the description, or may be learned by practice of the invention.

The foregoing and/or other aspects of the present general inventive concept are achieved by providing a display apparatus having a display panel displaying an image thereon, the display apparatus including: a graphic user interface (GUI) generator providing a graphic user interface (GUI) to set an afterimage elimination area, in which an after image is eliminated, on the display panel; a user input unit allowing a user to set the afterimage elimination area through the graphic user interface; and a controller controlling the GUI generator to display an afterimage elimination image in the afterimage elimination area set by operating the user input unit on the display panel.

According to an aspect of this embodiment of the general inventive concept, the graphic user interface may include a position input field to input a position value for the afterimage elimination area on the display panel by operating the user input unit, and the controller can control the GUI generator to display the afterimage elimination image on the display panel at a position corresponding to the position value inputted through the position input field.

According to another aspect of this embodiment of the present general inventive concept, the graphic user interface may include a size input field to input a size value for the afterimage elimination area on the display panel by operating the user input unit, and the controller can control the GUI generator to display the afterimage elimination image having a size corresponding to the size value inputted through the size input field.

According to another aspect of this embodiment of the present general inventive concept, at least one of the position value inputted through the position input field and the size value inputted through the size input field can be inputted by a pixel of the display panel.

According to yet another aspect of this embodiment of the present general inventive concept, the graphic user interface may include an area selection block having a predetermined size and a predetermined shape to define the afterimage elimination area, and the controller can control the GUI generator to visually change the position of the area selection block on the display panel in correspondence to operation of the user input unit.

According to yet another aspect of this embodiment of the present general inventive concept, the controller can control the GUI generator to visually change the size of the area selection block on the display panel in correspondence to an operation of the user input unit.

According to still another aspect of this embodiment, the graphic user interface may include a time input field to set a displaying time how long to display the afterimage elimination image by operating the user input unit, and the controller can control the GUI generator to display the afterimage elimination image during the displaying time set through the time input field.

According to still another aspect of this embodiment, the graphic user interface may include a pattern input field to set a displaying pattern of the afterimage elimination image by operating the user input unit, and the controller can control the GUI generator to display the afterimage elimination image with the displaying pattern selected through the pattern input field.

The foregoing and/or other aspects of the present general inventive concept may also be achieved by providing a method of eliminating an afterimage in a display apparatus having a display panel displaying an image thereon, the method including: displaying a graphic user interface to set an afterimage elimination area, in which an after image is eliminated, on the display panel; setting the afterimage elimination area through the graphic user interface; and displaying an afterimage elimination image in the afterimage elimination area set.

According to an aspect of this embodiment of the present general inventive concept, the displaying of the graphic user interface may include displaying a position input field to set a position of the afterimage elimination area on the display panel, and the setting the afterimage elimination area may include inputting a position value for the afterimage elimination area on the display panel through the position input field.

According to another aspect of this embodiment of the general inventive concept, the displaying of the graphic user interface may include displaying a size input field to set a size of the afterimage elimination area on the display panel, and the setting of the afterimage elimination area may include inputting a size value for the afterimage elimination area through the size input field.

According to another aspect of this embodiment of the present general inventive concept, the displaying of the graphic user interface may include displaying an area selection block having a predetermined size and a predetermined shape to define the afterimage elimination area, and the setting the afterimage elimination area comprises visually changing the size and the position of the area selection block on the display panel in correspondence to the position value inputted through the position input field and the size value inputted through the size input filed.

According to yet another aspect of this embodiment of the present general inventive concept, the displaying of the graphic user interface may include displaying a time input field to set a displaying time how long to display the afterimage elimination image, and the displaying of the afterimage elimination image in the afterimage elimination area may include displaying the afterimage elimination image in the afterimage elimination area during the displaying time set through the time input field.

According to still another aspect of this embodiment of the present general inventive concept, the displaying the graphic user interface includes displaying a pattern input field to set a displaying pattern of the afterimage elimination image, and the displaying the afterimage elimination image in the afterimage elimination area comprises displaying the afterimage elimination image having the displaying pattern selected through the pattern input field in the afterimage elimination area.

### BRIEF DESCRIPTION OF THE DRAWINGS

These and/or other aspects and advantages of the present general inventive concept will become apparent and more readily appreciated from the following description of the embodiments, taken in conjunction with the accompany drawings of which:

FIG. 1 is a control block diagram of a display apparatus according to an embodiment of the present general inventive concept;

FIGS. 2 through 5 illustrate a graphic user interface displayed on a display panel of the display apparatus of FIG. 1; and

FIG. 6 illustrates an afterimage elimination image displayed in an afterimage elimination area, which is set in the display apparatus of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

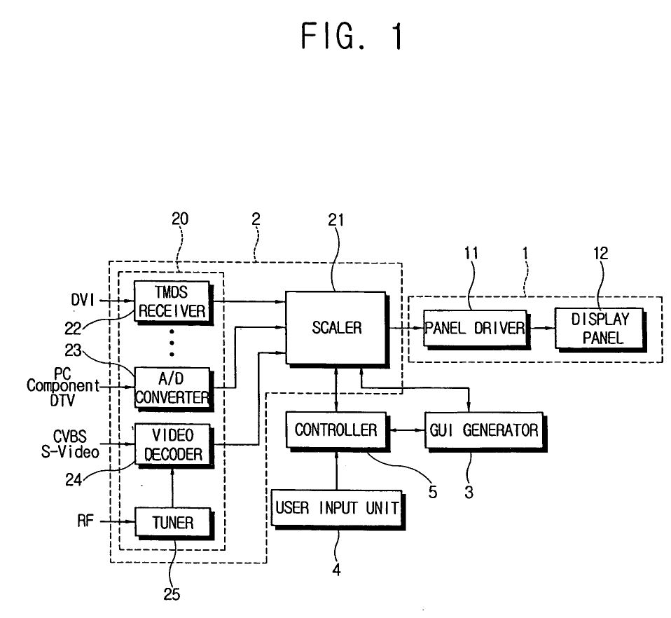

As shown in FIG. 1, a display apparatus according to an embodiment of the present general inventive concept includes a display 1, a signal processor 2, a graphic user interface (GUI) generator 3, a user input unit 4, and a controller 5.

The display 1 receives a video signal from the signal processor 2 to display a picture. The display 1 can include a display panel 12 on which a picture is displayed, and a panel driver 11 driving the display panel 12 to display a picture based on the video signal received from the signal processor 2. In this embodiment, the display panel 12 may include an LCD panel, a PDP, or the like in which an afterimage may linger after a predetermined time has passed since the still picture has first been displayed.

The signal processor 2 includes a scaler 21 to scale the video signal, and a signal converter 20 to convert the received video signal into the video signal adapted to be processed by the scaler 21. In this embodiment, the signal converter 20 may include a transition minimized differential signaling (TMDS) receiver 22, an analog/digital (A/D) converter 23, a video decoder 24, a tuner 25, etc.

The TMDS receiver 22 may receive a digital video signal, such as a digital video interface (DVI) signal from an external source, through a digital connector (not shown), and can devide the digital signal into a red, green, blue (RGB) signal and a horizontal/vertical (H/V) synchronous signal, thereby outputting the RGB signal and the H/V synchronous signal to the scaler 21. The A/D converter 23 may receive an analog video signal, such as a component signal and a personal computer signal to convert the analog video signal into a digital video signal, thereby outputting the converted digital video signal to the scaler 21. The video decoder 24 can receive an analog video signal, such as a composite video broadcast signal (CVBS) and an S-video signal, through an analog connector, to decode the CVBS or the S-video signal, thereby outputting the decoded CVBS or the decoded S-video signal to the scaler 21. The tuner 25 receives a radio frequency (RF) signal, such as a broadcast signal, through an antenna (not shown), and outputs the RF signal to the video decoder 24.

The user input unit 4 may output a key signal to the controller 5 when operated by a user. In this embodiment, the user input unit 4 can include a control button provided at a front portion of the display apparatus, and a key signal generator to generate a key signal corresponding to a key operation of the control button. When a user operates the control button, the key signal generator can generate the key signal corresponding to the key operation of the control button to output the key signal to the controller 5. Thus, the controller 5 can control the signal processor 2, the GUI generator 3, etc., in response to the key signal inputted from the key signal generator. Alternately, the user input unit 4 may include a wireless remote controller to output an optical signal when operated by a user, and an optical signal receiver provided in the display apparatus to output the key signal to the controller 5 in response to the optical signal received from the wireless remote controller.

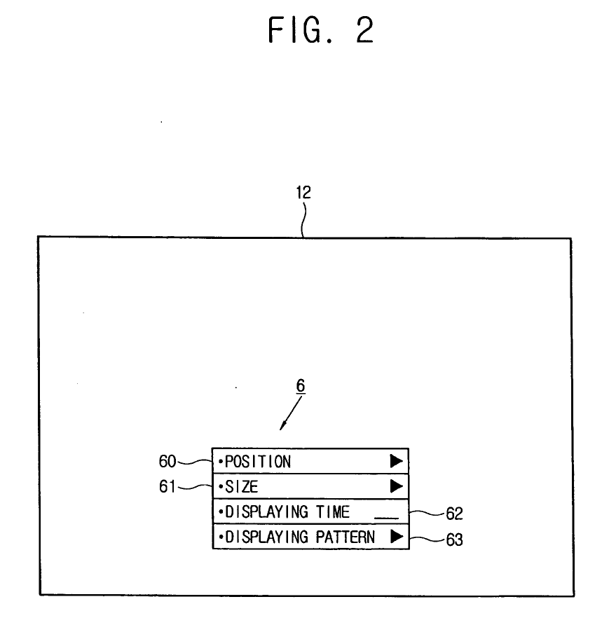

The GUI generator 3 can display a graphic user interface 6 (see, for example, FIGS. 2-5) on the display panel 12, thereby allowing a user to set an afterimage elimination area. That is, the video signal for the graphic user interface 6 outputted from the GUI generator 3 is synthesized with the video signal outputted from the scaler 21 and displayed on the display panel 12. Thus, a user can set the afterimage elimination area through the graphic user interface 6 by operating the user input unit 4, wherein the afterimage elimination area is a part of the display panel 12 to which an afterimage elimination is applied. In an aspect of the general inventive concept, the GUI generator 3 may be an on screen display (OSD) generator to display an OSD.

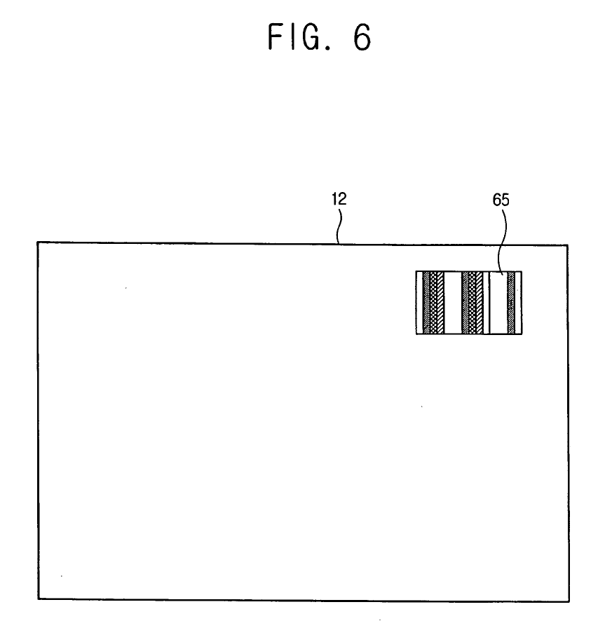

The controller 5 can control the GUI generator 3 to display an afterimage elimination image 65 (refer to FIG. 6) on the afterimage elimination area of the display panel 12, which is set through the user input unit 4 by a user. Hence, the display apparatus according to the present general inventive concept can apply the afterimage elimination to a specific area of the display panel 12, that is, applies the afterimage elimination to only the afterimage elimination area which is set through the user input unit 4, so that the video signal is normally displayed on the display panel 12 except for the afterimage elimination area.

In the display apparatus according to an embodiment of the present general inventive concept, setting the afterimage elimination area and applying the afterimage elimination to the set afterimage elimination area will be described herein below with reference to FIGS. 2 through 6.

First, when a user selects the afterimage elimination through the user input unit 4, the user input unit 4 can transmit a key signal corresponding to the afterimage elimination, and the controller 5 controls the GUI generator 3 to display the graphic user interface 6 on the display panel 12 in response to the key signal transmitted from the user input unit 4.

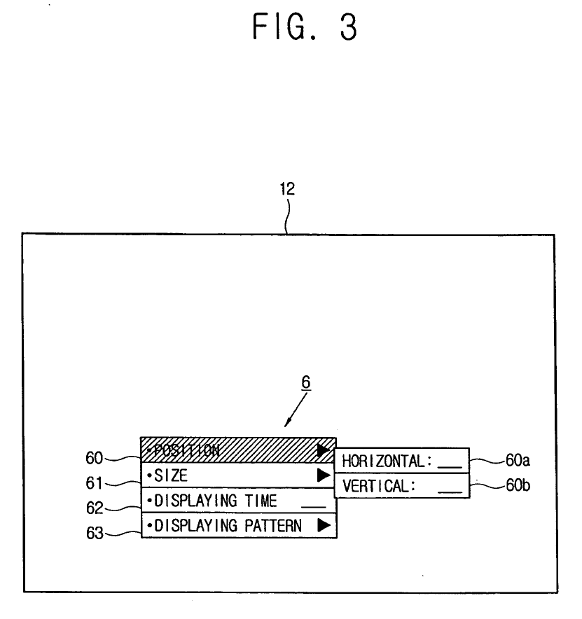

FIG. 2 illustrates the graphic user interface 6 displayed on the display panel 12. As shown in FIG. 2, the graphic user interface 6 according to an embodiment of the present general inventive concept can include a position input field 60. The position input field 60 can be used to allow a user to set a position of the afterimage elimination area on the display panel 12 by operating the user input unit 4. In this embodiment, when a user selects the position input field 60, a horizontal position input field 60a and a vertical position input field 60b can be displayed, as shown in FIG. 3. The horizontal position input field 60a allows a user to input a horizontal position value for the afterimage elimination area on the display panel 12, and the vertical position input field 60b allows a user to input a vertical position value for the afterimage elimination area on the display panel 12. Thus, a user can input the horizontal and vertical position values to set where the afterimage elimination area is positioned on the display panel 12 through the horizontal and vertical position input fields 60a and 60b, thereby setting the position of the afterimage elimination area on the display panel 12. Then, the controller 5 can control the GUI generator 3 to display the afterimage elimination image 65 on the display panel 12 at the position based on the inputted position values.

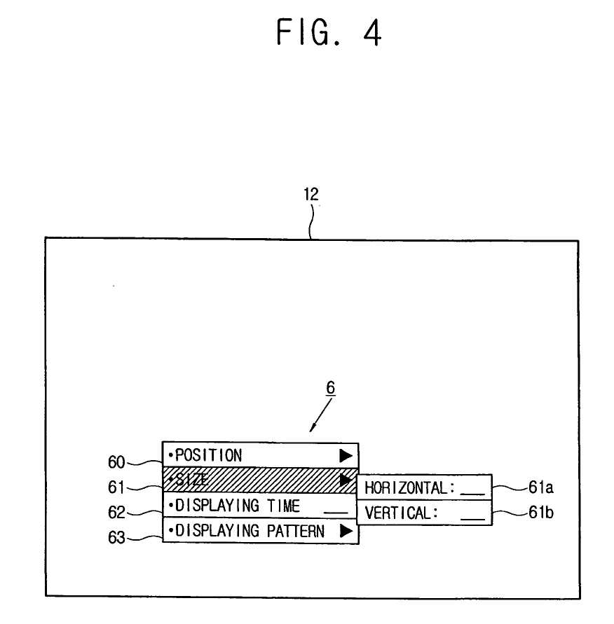

Further, as shown in FIGS. 2 and 4, the graphic user interface 6 according to an embodiment of the present general inventive concept can include a size input field 61. The size input field 61 can be used to allow a user to set a size of the afterimage elimination area by operating the user input unit 4. In this embodiment, when a user selects the size input field 61, a horizontal size input field 61a and a vertical size input field 61b can be displayed, as shown in FIG. 4. The horizontal size input field 61a allows a user to input a horizontal size value for the afterimage elimination area, and the vertical size input filed 61b allows a user to input a vertical size value for the afterimage elimination area. Thus, a user can input the horizontal and vertical size values to set the size of the afterimage elimination area through the horizontal and vertical size input fields 61a and 61b, thereby setting the size of the afterimage elimination area. Then, the controller 5 can control the GUI generator 3 to display the afterimage elimination image 65 (see FIG. 6) on the display panel 12, wherein the afterimage elimination image 65 has the size based on the inputted size values.

Further, as shown in FIG. 2, the graphic user interface 6 according to an embodiment of the present general inventive concept can include a time input field 62. The time input field 62 can be used to allow a user to set a displaying time of how long to display the afterimage elimination image 65 in the foregoing set afterimage elimination area by operating the user input unit 4. Thus, the controller 5 can control the GUI generator 3 to display the afterimage elimination image 65 during the displaying time set through the time input field 62.

Further, as shown in FIG. 2, the graphic user interface 6 according to an embodiment of the present general inventive concept can include a pattern input field 63. The pattern input field 63 can be used to allow a user to set a displaying pattern of the afterimage elimination image 65. Here, when a user selects the pattern input field 63, a displaying pattern window (not shown) having at least one registered displaying pattern can be displayed as an example of the afterimage elimination image 65. Then, when a user selects one of the registered displaying patterns, the controller 5 can control the afterimage elimination image 65 to be displayed with the selected displaying pattern.

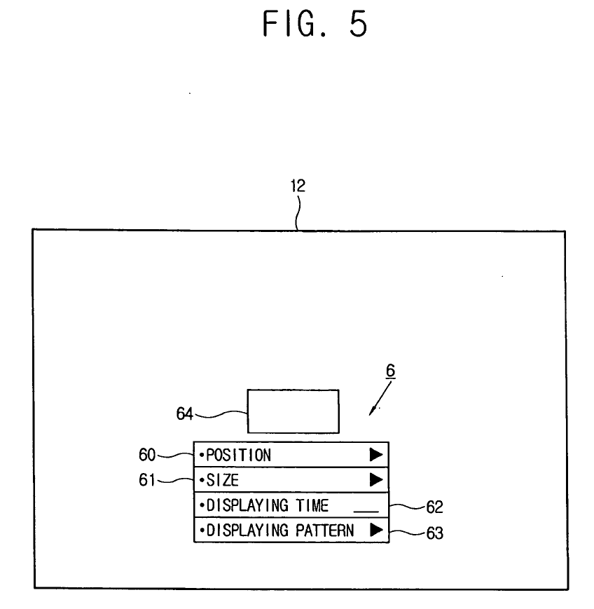

Further, as shown in FIG. 5, the graphic user interface 6 according to an embodiment of the present general inventive concept can include an area selection block 64 having a predetermined size and a predetermined shape to define the afterimage elimination area. In this embodiment, the area selection block 64 has a rectangular shape, but may have various shapes.

The area selection block 64 can be activated at a predetermined position of the display panel 12 when the graphic user interface 6 is displayed. Here, the area selection block 64 can move corresponding to the inputted position values and has the size corresponding to the inputted size values when a user inputs the position values and the size values through the position input field 60 and the size input field 61. Thus, a user can visually check the afterimage elimination area by referring to the area selection block 64 displayed on the display panel 12 corresponding to the position and size values inputted through the position and size input fields 60 and 61.

FIG. 6 illustrates the afterimage elimination image 65 having the set displaying patterns by way of example, which is displayed in the foregoing set afterimage elimination area.

In the above-described embodiments, a user can input the position and size values for the afterimage elimination area as a numerical value through the position input fields 60 and 61 of the graphic user interface 6, respectively, and the position and the size of the area selection block 64 can be adjusted corresponding to the inputted position and size values. However, the position and/or the size of the area selection block 64 on the display panel 12 may be adjusted not by inputting a numerical value, but by instead operating the user input unit 4. For example, by way of a key operation of the user input unit 4 to adjust the position or the size on the display panel 12.

As described above, there are provided the GUI generator 3 providing the graphic user interface 6 to set the afterimage elimination area on the display panel 12; the user input unit 4 allowing a user to set the afterimage elimination area through the graphic user interface 6; and a controller 5 controlling the GUI generator 3 to display the afterimage elimination image 65 in the afterimage elimination area of the display panel 12, wherein the afterimage elimination area is set by operating the user input unit 4, so that the afterimage elimination can be applied to only the specific area of the display panel 12. Therefore, a user can eliminate the afterimage from only the specific area (i.e., the set afterimage elimination area) of the display panel 12 while watching the whole picture displayed on the display panel 12.

As described above, the present general inventive concept provides a display apparatus and a method of eliminating an afterimage, in which an after image elimination can be applied to only a specific area of a display panel.

Although a few embodiments of the present general inventive concept have been shown and described, it will be appreciated by those skilled in the art that changes may be made in these embodiments without departing from the principles and spirit of the invention, the scope of which is defined in the appended claims and their equivalents.

1. A display apparatus having a display panel displaying an image thereon, comprising:
a GUI generator providing a graphic user interface to set an afterimage elimination area in which an after image is to be eliminated on the display panel;
a user input unit allowing setting of the afterimage elimination area through the graphic user interface; and
a controller controlling the GUI generator to display an afterimage elimination image in the afterimage elimination area set by an operation of the user input unit on the display panel.

2. The display apparatus according to claim 1, wherein the graphic user interface comprises a position input field to input a position value for the afterimage elimination area on the display panel by operating the user input unit, and the controller controls the GUI generator to display the afterimage elimination image on the display panel at a position corresponding to the position value inputted through the position input field.

3. The display apparatus according to claim 2, wherein the graphic user interface comprises a size input field to input a size value for the afterimage elimination area on the display panel by operating the user input unit, and the controller controls the GUI generator to display the afterimage elimination image having a size corresponding to the size value inputted through the size input field.

4. The display apparatus according to claim 3, wherein at least one of the position value inputted through the position input field and the size value inputted through the size input field is inputted by a pixel of the display panel.

5. The display apparatus according to claim 1, wherein the graphic user interface comprises an area selection block having a predetermined size and a predetermined shape to define the afterimage elimination area, and the controller controls the GUI generator to visually change the position of the area selection block on the display panel in correspondence to an operation of the user input unit.

6. The display apparatus according to claim 5, wherein the controller controls the GUI generator to visually change the size of the area selection block on the display panel in correspondence to an operation of the user input unit.

7. The display apparatus according to claim 2, wherein the graphic user interface comprises an area selection block having a predetermined size and a predetermined shape to define the afterimage elimination area, and the controller controls the GUI generator to visually change the position of the area selection block on the display panel in correspondence to an operation of the user input unit.

8. The display apparatus according to claim 3, wherein the graphic user interface comprises an area selection block having a predetermined size and a predetermined shape to define the afterimage elimination area, and the controller controls the GUI generator to visually change the position of the area selection block on the display panel in correspondence to an operation of the user input unit.

9. The display apparatus according to claim 1, wherein the graphic user interface comprises a time input field to set a displaying time how long to display the afterimage elimination image by operating the user input unit, and the controller controls the GUI generator to display the afterimage elimination image during the displaying time set through the time input field.

10. The display apparatus according to claim 2, wherein the graphic user interface comprises a time input field to set a displaying time how long to display the afterimage elimination image by operating the user input unit, and the controller controls the GUI generator to display the afterimage elimination image during the displaying time set through the time input field.

11. The display apparatus according to claim 3, wherein the graphic user interface comprises a time input field to set a displaying time how long to display the afterimage elimination image by operating the user input unit, and the controller controls the GUI generator to display the afterimage elimination image during the displaying time set through the time input field.

12. The display apparatus according to claim 1, wherein the graphic user interface comprises a pattern input field to set a displaying pattern of the afterimage elimination image by operating the user input unit, and the controller controls the GUI generator to display the afterimage elimination image with the displaying pattern selected through the pattern input field.

13. The display apparatus according to claim 2, wherein the graphic user interface comprises a pattern input field to set a displaying pattern of the afterimage elimination image by operating the user input unit, and the controller controls the GUI generator to display the afterimage elimination image with the displaying pattern selected through the pattern input field.

14. The display apparatus according to claim 3, wherein the graphic user interface comprises a pattern input field to set a displaying pattern of the afterimage elimination image by operating the user input unit, and the controller controls the GUI generator to display the afterimage elimination image with the displaying pattern selected through the pattern input field.

15. A method of eliminating an afterimage in a display apparatus having a display panel displaying an image thereon, the method comprising:
displaying a graphic user interface to set an afterimage elimination area, in which an afterimage is to be eliminated, on the display panel;
setting the afterimage elimination area through the graphic user interface; and
displaying an afterimage elimination image in the afterimage elimination area set.

16. The method according to claim 15, wherein the displaying of the graphic user interface comprises displaying a position input field to set a position of the afterimage elimination area on the display panel, and the setting the afterimage elimination area comprises inputting a position value for the afterimage elimination area on the display panel through the position input field.

17. The method according to claim 16, wherein the displaying of the graphic user interface comprises displaying a size input field to set a size of the afterimage elimination area on the display panel, and the setting the afterimage elimination area comprises inputting a size value for the afterimage elimination area through the size input field.

18. The method according to claim 17, wherein the displaying of the graphic user interface comprises displaying an area selection block having a predetermined size and a predetermined shape to define the afterimage elimination area, and the setting the afterimage elimination area comprises visually changing the size and the position of the area selection block on the display panel in correspondence to the position value inputted through the position input field and the size value inputted through the size input filed.

19. The method according to claim 17, wherein the displaying of the graphic user interface comprises displaying a time input field to set a displaying time how long to display the afterimage elimination image, and the displaying the afterimage elimination image in the afterimage elimination area comprises displaying the afterimage elimination image in the afterimage elimination area during the displaying time set through the time input field.

20. The method according to claim 17, wherein the displaying of the graphic user interface comprises displaying a pattern input field to set a displaying pattern of the afterimage elimination image, and the displaying the afterimage elimination image in the afterimage elimination area comprises displaying the afterimage elimination image having the displaying pattern selected through the pattern input field in the afterimage elimination area.

21. A display apparatus comprising:
a display panel to display an image thereon; and
an afterimage elimination unit to eliminate an afterimage on a specific area of the display panel.

22. The display apparatus of claim 21, wherein the afterimage elimination unit includes:
a graphic user interface to set an area in which the afterimage of the display panel is to be eliminated;
a user input unit allowing setting of the area in which the afterimage is to be eliminated through the graphic user interface; and
a controller to control the graphic user interface to display an afterimage elimination image in the afterimage elimination area set by operating the user input unit on the display panel.

23. The display apparatus of claim 21, wherein the afterimage elimination unit generates an afterimage elimination image corresponding to the afterimage according to at least one of a position, a size, a displaying time, and a display pattern of the specific area of the display panel.

24. A method of eliminating an afterimage in a display apparatus having a display panel displaying an image thereon, the method comprising:
selecting an afterimage elimination area of the display panel in which an after image is to be eliminated; and
displaying an afterimage elimination image in the selected afterimage elimination area.

25. The method according to claim 24, wherein the selecting of the after image elimination area comprises:
displaying a graphic user interface to select the afterimage elimination area on the display panel in which the after image is to be eliminated; and
selecting the afterimage elimination area through the displayed graphic user interface.
